(19) United States
(12) Patent Application Publication
(10) Pub. No.: US 2019/0292467 A1
(43) Pub. Date: Sep. 26, 2019

(54) OIL PRODUCTS DERIVED FROM DILUTED PYROLYSIS GAS BY CONTINUOUS MILD-TEMPERATURE PYROLYSIS COAL-TAR SEPARATION PROCESS

(71) Applicant: Dennis Carl England, Coto de Caza, CA (US)

(72) Inventor: Dennis Carl England, Coto de Caza, CA (US)

(73) Assignee: Convert Coal, Inc., Irvine, CA (US)

(21) Appl. No.: 15/936,227

(22) Filed: Mar. 26, 2018

(51) Int. Cl. C10B 53/06; C10B 49/02; B01D 5/00; C10B 57/14

(52) U.S. Cl. CPC C10B 53/06; C10B 57/14; B01D 5/0036; C10B 49/02

(57) ABSTRACT

The present invention pertains to the recovery, separation and the unique product mixtures obtained by recovery and separation of coal-tar oils produced from low-rank-coal by a novel mild-temperature pyrolysis [MTP] process originating at the point where the vapor phase exits the pyrolysis reactor. Mild-temperature pyrolysis [MTP] takes place below 1200° F. in contrast to the high-temperature pyrolysis [HTP] that is operated at 1600-2000° F. for coke oven processing of metallurgical coke. The yield and composition of coal-tar-oil recovered from MTP are quite different from HTP coal-tar. In order to optimize the oil recovery process, the most appropriate recovery and separation processes therefore also will be different. The MTP process produces coal-tar containing a major fraction of strongly polar compounds mixed with non-polar compounds that separates into several liquid phases and overlap in their distillation ranges. This invention addresses the distinct product fractions obtained from MTP and the integrated multi step oil recovery and product separation process, which is designed with the objective to improve and facilitate the product separation, decrease the required amount of energy for separation and equipment cost for downstream processing.

### CROSS-REFERENCE TO RELATED APPLICATION

This application claims the benefit of priority to U.S. Provisional Patent Application No. 62/601,566, filed Mar. 27, 2017, entitled “Recovery Process for Mild-Temperature Pyrolysis Oil from Diluted Pyrolysis Gas” and U.S. Provisional Patent Application No. 62/601,551, filed Mar. 27, 2017, entitled “Oil Products Derived from Continuous Process Mild-Temperature Pyrolysis Coal-Tar Separation”, the content of which is hereby incorporated by reference in their entireties.

### FIELD OF INVENTION

The present invention relates to a process for recovering coal-tar-oil produced from a continuous mild-temperature pyrolysis of low-rank-coal, and more particularly, to a process for recovering coal-tar-oil in a stepwise manner to produce distinct coal-tar fractions suitable for downstream processing and commercial products.

### BACKGROUND

Low Rank Coal (LRC) represents a majority of coal deposits in the Western USA and in the world. LRC deposits often are located close to the surface, and therefore can be mined inexpensively compared to higher-rank coals. The economic fuel value of LRC is less due to the presence of significant amount of moisture and oxygenated chemical compounds. The less economical fuel-value can be attributed to the added weight, extra heat required to evaporate the moisture and increased transportation costs to the point of use. Nevertheless, in the U.S. during the last twenty years, LRC has become the major source of fuel for coal-fired utility boilers because of its low sulfur content and increasing restrictive air emission targets for steam boilers.

LRC can be upgraded by coal drying. Coal drying processes operate at 450-500° F. and typically remove 85-95% of the moisture plus 20-30% of the sulfur present depending on the feed-coal and operation. The fuel value is increased in proportion to the amount of water removed, e.g., from 8400-Btu/lb to 11500-Btu/lb for a LRC containing 30 w % water. The resulting fuel efficiency increased for power generation may exceed 5%. Coal drying at 450-500° F. maintains the open pore structure of the coal. During storage and transportation dried coal tends to absorb moisture and oxygen from the atmosphere to reach its equilibrium moisture level. The heat releases due to re-absorption of moisture and oxygen from the air will cause self-heating of the coal, which in turn can lead to spontaneous combustion of the dried coal.

High temperature pyrolysis [HTP] is operated at 1600-1800° F. and is used for high-rank-coals for the production of metallurgical coke. LRC generally is unsuitable for processing into metallurgical coke due to its tendency to disintegrate into coal-fines at operating temperature used in high temperature pyrolysis process. Mild temperature pyrolysis [MTP], operates at a more moderate temperature in the range of 950-1100° F. In addition to removal of moisture from coal feedstock, Mild temperature pyrolysis process also provides sufficient thermal energy to remove part of the volatile matter present in the coal feedstock. The coal structure is modified somewhat and parts of the coal converts into lower molecular weight volatile compounds. Depending on the composition and reactivity of the feed-coal, the designated operating temperature and residence time, a significant fraction of the LRC can be volatilized and recovered as condensable coal-tar-oil and minor amounts of fuel-gas. For example, MTP processing of an 8400-Btu/lb LRC with 30 w % water and 30 w % volatile matter can produce 10-15 w % coal-tar-oil and a dry 11500-Btu/lb coal-char fuel with less sulfur content, 15-20 w % remaining volatile matter. The recovered oil phase can be used as synthetic crude oil feedstock for petroleum refining and coal-tar-chemicals extraction.

Coal-tar-oil recovered from Mild Temperature Pyrolysis (MTP) processing differs significantly from coal-tar derived from High Temperature Pyrolysis (HTP) due to the use of different feed-coal and process temperatures along with different processing parameters. The different processing parameters generally include heat-transfer gradients, equipment configuration, residence time of coal mass at a particular temperature, use of inert sweeping gas, and oil recovery process design. The HTP volatilizes a higher boiling coal-tar fraction at temperature range of 1100-1800° F. whereas in the MTP maximum operating temperature is 1100° F. The elevated temperature in HTP process tends to cause thermal cracking and polymerization of parts of the recoverable volatilized oil. Those skilled in the art will readily understand the importance of optimization of the MTP process and subsequent oil recovery process to match the unique requirements of the vapor composition, and to optimize the oil recovery yield, efficiency and heat recovery.

The mild temperature pyrolysis of low rank coal result in the formation of coal-char as end-product and coal-tar oil and pyrolysis gas as by-product. The coal-tar-oil can be converted to synthetic crude oil for extraction and refining of petroleum and coal-tar derived specialty products. Syncrude oil can be obtained by hydrotreating, hydrocracking or coking of the entire coal-tar-oil or selected fractions recovered from the coal-tar oil. Coal-tar derived products are obtained by fractionation of the recovered coal-tar by distillation and solvent extraction or combinations thereof. Certain fractions of the coal-tar may have considerable higher values than other fractions, therefore, separation of the higher value fractions is desirable. It is therefore desirable for economic reasons that the coal-tar-oil recovery process performs an initial fractionation to yield different fractions of coal-tar oil, which then undergoes downstream fractionation and upgrading processes. These concerns for overall process optimization are addressed directly in the present invention.

The literature describing coal pyrolysis is extensive, going back more than a hundred years, and deals primarily with high temperature pyrolysis of coal to obtain metallurgical quality coke for ore reduction and the recovery of the high temperature coal-tar chemicals. However, relatively few references deal with mild temperature pyrolysis of low ranking coal; and few references address the coal-tar-oil recovery process in other than generic terms, and few if any address design optimization for product fractionation, energy recovery or economic optimization. The major conversion processes and apparatus available for converting coal into oil and other forms of fuel were surveyed by [1] Howard-Smith and Werner, COAL CONVERSION TECHNOLOGY, Noyes Data Corporation, Park Ridge, N.J., 1976, Chemical Technology Review No. 66; [2] Richardson, OIL FROM COAL, Noyes Data Corporation, Park Ridge, N.J., 1975, Chemical Technology Review No. 53, and [3] Kirk-Othmer, ENCYCLOPEDIA OF CHEMICAL TECHNOLOGY, Second Edition, Volume 5 and Second Edition Supplement Volume, Pages 178-198.

During the early 1880s a retort type of coke oven was developed in Germany to minimize the amount of oxygen to which the coal was exposed in the pyrolysis process and to produce a better quality of coke and more coal-tar byproducts. In this design the coal is placed in a set of slab-shaped chambers approximately a foot thick, 10 ft high, and 20 to 40 ft long. These chambers are placed side by side to form large oven assemblies in which the coal is heated to about 1800° F. by hot combustion gases circulated through passages in the walls between adjacent chambers. The time required for heating the coal charge is 10-20 hours due to the relatively long path for heat flow and low rate of gas evolution resulting from the compactness of the charge. The yield of condensable coal-tar-oil is only 1 to 2 w % of the feed-coal, and non-condensable fuel gas is about 3 w %.

The development of town-gas plants based on an intermittent process cycle of heating [C+O2=CO2+heat release] and water-gas reaction [C+H2O+heat=>CO+H2] culminated with the successful system for gasifying coal to “synthesis gas” [CO+H2] designed by Lurgi in Germany in the 1920's. To increase the throughput rate and reduce capital costs, coal enters the top of a large cylindrical vessel, air and steam flow up through a grate at the bottom, and the coal bed above the grate is stirred slowly to keep the charge movable and to increase the effective surface area. Ash is removed from the bottom and the volatilized gases produced flows out the top of the vessel where they are collected and condensed. After removal of coal-tar-oils and water, the remaining synthesis-gas is suitable for production of liquid motor fuel using the “F-T process” developed in Germany in 1923 by Franz Fischer and Hans Tropsch and deployed during the 1940s in Germany for production of up to 70,000-b/d diesel fuel. The Lurgi coal gasification process aims at full conversion to synthesis-gas and F-T-synthesis and it is noteworthy that the recovered high-temperature pyrolysis coal-tar-oils contributes little to oil supply due to the available quantity and quality.

Subsequent efforts of MTP process development in Germany, Japan and the U. S. during the 1970s-1990s have been unsuccessful, that include processes featuring fluidized beds, tunnel ovens and horizontal grates. This can be explained in part due to serious operating troubles with coking taking place in the pyrolysis retorts, corrosion and pipe-line clogging by waxy and tarry deposits, and the high estimates of costs combined with the unstable price of petroleum oil during that period. During the period 1960-2000, the only commercial plant in the world producing liquid motor fuel from coal was the SASOL plant in South Africa employing Lurgi gasification technology and F-T-synthesis of diesel fuel heavily subsidized by the government.

Although oil yield, selectivity and quality of the MTP pyrolysis liquids are primary considerations, the paramount consideration is the operability of the process. Those skilled in the art of coal gasification and liquefaction have been frustrated by the formation of coke deposits bringing the process to a halt. Uncontrolled coking can present problems so intractable that the useful type of coal is limited, and the coal throughput rate must be kept low so that the raw coal represents a small fraction of the total amount of particulate matter active in the process. For example, unless a non-caking coal is employed even the rugged stiffing equipment used in the Lurgi gasifier will stall.

In several studies of fluidized bed pyrolysis systems designed to produce liquid syncrude hydrocarbon feedstock for refining into motor fuels, it was found that the fine carbon particles entrained with the recovered oil were highly active polymerization catalysts for converting the recovered coal-tar-oil into polymer gels within a few days. For example, in tests of the COED bubbling bed and the Occidental entrained bed, coal-fines were 3 to 10 w % of the condensable product, and that in other systems they were as much as 30% by weight.

The technical capability of MTP to produce commercially useful products has been abundantly demonstrated. These products include synthetic crude (syn-crude) oil obtained from converting the entire recovered coal-tar-oil or fractions thereof by hydrotreating as demonstrated, for example, by SASOL and US-DOE. Other higher value products include coal-tar derived chemicals based on N-bases, cresol and cresylic acid separation as practiced by COALITE in Britain; wax compounds similar to Montan wax [solvent extracted from bituminous coals] and petroleum slack-wax products; and coal-tar-pitch fractions suitable for use as a component in electrode binder pitch as reported by Knight, IGT in a 1993 report: Upgrading Mild Gasification Liquids To Produce Electrode Binder Pitch, DOE Grant Number, DE-FC22-92PC92521 (year 2), ICCI Project Number 93-1/1.3A-3M, Principal Investigator: R. A. Knight, Institute of Gas Technology and Project Manager: D. Banerjee, Ill. Clean Coal Institute.

U.S. Pat. No. 1,814,463 July, 1931, Trent., describes MTP using a horizontal travelling grate for pyrolysis providing several heating zones and oil recovery zones, but without providing practical means to segregate these operating zones, and without accounting for the simultaneous vaporization of high and low boiling oil compounds taking place in the high temperature heating zones, which renders the segmented condensation ineffective for fractionation of the oil compounds.

U.S. Pat. No. 4,395,309, 1983, Esztergar et al., describes a mild temperature pyrolysis [MTP] process for LRC using horizontal moving bed with combination of radiant heating and direct heating with inert gas at 1050° F. while using two distinct layers of coal. The top recycle-coal layer is pyrolyzed while the bottom feed-coal layer is cooled and acting as condenser for the vaporized coal-char. The patent teaches that optimum operating temperature ranges will depend upon a number of factors within the discretion and choice of the operator. These include considerations of the quality of the coal, the ease of distillation, relative availability of volatile material in the selected coal feedstock, the relative content of light oil distillates and heavy oil distillates, the desired product mix and the marketability and market price of particular cuts of the distillate. The process aims at recovering the coal-tar in several fractions, but no functional means are provided for obtaining reliable fractionation. Furthermore, no means is described to control the temperatures of the condensed coal-tar adequately to prevent the high-boiling pitch and wax compounds from plugging the condensing surfaces on the lower layer of coal, the moving grate or any downstream pans, vessels and conduits. It is of interest that the design of the SGI/DOE demonstration plant [ENCOAL, 1000-t/d, operated 1992-1997], which was based in part on this patent, found it desirable to abandon several of the patented design features; e.g., provisions for two separate coal layers, the tunnel oven design and collection of multiple separate condensing oil fractions.

U.S. Pat. No. 5,354,429 by Duncan et al, 1994 teaches the purification of cresylic acids by extractive distillation whereby highly purified material can be obtained with relatively low energy consumption.

U.S. Pat. No. 5,401,364 by Rinker, 1994, describes a LRC pyrolysis process in which the heat is provided by recycle gas obtained by combustion of pyrolysis gas and auxiliary fuels. The patent teaches the importance of process optimization to meet coal-char specifications suitable for power plant boilers, and the critical issues of process design for reliable operation; however, the recovery and separation of pyrolysis oil vapors are not addressed. The MTP process is based on direct inert gas heating where the ratio of heating gas to feed-coal is 2.14:1.0, which translates to 6.2-w % oil to gas [based on an assumed oil yield of 264-lb oil per ton feed-coal]. This large dilution of the vaporized coal-tar-oil impedes the oil recovery process, and contact of large volumes of 1-5 w % oxygen containing gas with the oil vapor at elevated temperature reduces the quality and volume of the recovered oil. These operating concerns are addressed in the present invention.

U.S. Pat. No. 547,549, 1995, A. Fraas, describes a MTP using an atmospheric fluidized bed [AFB] in combination with a “vibrating bed pyrolyzer” [VBP] unit to recover pyrolysis gas and condensable oil for use primarily as fuel for combustion-turbine power generation. The heating is accomplished by direct hot gas heating of the AFB and indirect heating of the VBP unit; but the heat and mass balances for the designated gas/coal ratios do not provide sufficient means to attain the desired operating temperatures. These concerns the capital cost and captive energy losses associated with the AFB/VBP design would be the reasons why this process never was implemented commercially during the past 75 years.

U.S. Pat. No. 5,601,692 by Rinker et al, describes a novel control system for monitoring and controlling a MTP process for LRC in order to optimize the quality of the produced coal-char and coal-tar-oil; however it does not address or define the oil recovery process.

The specific problems encountered in the design for coal-tar-oil recovery from the mild temperature pyrolysis process include the following: the mild temperature pyrolysis process require a certain amount of direct contact heating-gas in addition to indirect heating due to considerations of the coal processing, heat exchange adequacy, limitations in operating temperatures [coal-tar-oil reactivity, volatility, coal-tar-oil product specifications, metallurgical considerations], operating economics relating to cost of energy, and equipment cost.

The coal-tar-oil in the mild temperature pyrolysis process gets diluted by heating gas, pyrolysis gas [including pyrolysis reaction water], and inert gas which is used to modulate the heating-gas temperature [including water vapor due to its advantageous thermal characteristics]. The dilution of coal-tar-oil in pyrolysis effluent gas is in the range from 5 w % to 45 w %. In one design example, it has been shown that the weight % of the coal-tar-oil in the effluent was 21.5 while the volumetric as well as the molar concentration was only 3% due to the distribution of molecular weights in the effluent. This large dilution presents a severe challenge to the process design for optimized oil recovery.

The coal-tar-oil contains 100-1200 individual compounds with their boiling points between 212° F. and 1250° F., the concentrations of most part is typically below 1% of the oil. As a result of the low partial pressure the condensation point [dew point] of any given compound in large dilution in the gas phase is very far removed from its boiling point and it is therefore difficult to recover the oil from the gas phase. For example, at 21.6 w % [3%-molar or volume] oil on gas effluent and 16-psia operating pressure, a compound at a concentration of 1-molar % of the oil will have a partial pressure, Pj=1%×3-vol %×16-psia=0.0048-psia. In other words, condensation is effectively taking place at a high vacuum for each individual compound.

The recovery of at least 75%, or 85%, or better yet 95% or more of the condensable coal-tar-oil is imperative for economic success of the mild temperature pyrolysis processing of low rank coal. The economic result of the process can be seen to be almost totally dependent on the coal-tar-oil yield. Given the above reality of the oil recovery process conditions, extraordinary steps are warranted to recover the last 10, 5, or 1% of the oil.

The boiling range of coal-tar-oil produced from mild temperature pyrolysis of low rank coal is from 212° F.-1250° F. The higher boiling compounds tend to have very high viscosity or turn to solids at the lower temperatures where the “lower boilers” can condense. In addition the various family of compounds separate into several phases upon condensing. Both issues can cause operational difficulties due to phase separation, formation of emulsions and suspensions, increase in the viscosity of the mixtures, solid and tar deposits on surfaces in vessels, pipes and heat exchangers, and fouling of control instrumentation. These potential “operating problems” that are often overlooked or misunderstood in process design, have to be avoided by appropriate design.

The capital cost of the recovery process must be maintained within reasonable limits to support the project. The nature of the project is 10,000-t/d coal, 15004/d [62.54/h] CTO and 300-500-t/h pyrolysis gas and vapor effluent. These factors of capacity and equipment size limit the degree of high-tech processing and equipment that can be made use of in the process

A need therefore exists for an improved technology for producing syncrude oil, liquid fuels and feedstock from coal in countries with abundant coal resources. In particular, conversion of LRC provides an attractive feedstock based on the large proportion of these coal resources worldwide.

This invention pertains to the further design development and optimization of the recovery of condensable coal-tar-oil [CTO] from mild-temperature pyrolysis [MTP] of LRC [low-rank coal]. LRC has special characteristics and compositions that are different from high rank coals and coking coals, and the operating conditions also are very different, so the CTO and pyrolysis gas effluent therefore are significantly different in composition from metallurgical coke-oven coal-tar and gas material.

### SUMMARY OF THE INVENTION

The present invention provides a method and system for coal-tar-oil recovery and product separation from the pyrolysis vapor phase exiting from the mild temperature pyrolysis process. The present invention is based on a multi-step coal-tar-oil recovery process that meets the following set of objectives: (a) Facilitate the coal-tar-oil product recovery and separation in a way so that the high boiling point wax and pitch compounds present in the condensable coal-tar-oil do not impede the effective operation of the heat-exchange surfaces due to high viscosity and partial solidification at the lower temperatures required for the condensation of the other components in the oil; (b) Decrease the amount of cooling and energy required for oil recovery from the pyrolysis effluent stream while also optimizing the recovery of useful waste-heat as process steam; (c) Provide separation of the coal-tar-oil as part of the recovery process into several distinct, functional fractions in order to facilitate the downstream oil fractionation processes; (d) Decrease the processing cost and equipment capital cost of the overall mild temperature pyrolysis process and downstream fractionation set of processes.

The present invention addresses following concern regarding process operability, energy savings, energy recovery and capital cost optimization in a mild temperature pyrolysis process: (a) The composition of coal-tar-oil derived from LRC is different from that produced from feed coals used to produce metallurgical coke, and the composition of pyrolysis gas effluent derived from MTP processing is different from that produced by conventional high-temperature processes used for metallurgical coke; (b) In the MTP process the coal-tar-oil is diluted with stripping-gas and the partial pressures of the individual oil compounds therefore are commensurately decreased, impeding to some extent the recovery of condensable material from the gas phase; (c) The recovered coal-tar-oil boiling range at normal pressure is 150-1400° F. as MTP using gas stripping at 950-1100° F. vaporizes higher boiling compounds. The high-boiling wax and pitch fractions condense into high-viscosity oils and can solidify on the cooling surfaces at the lower temperatures required for condensation of the lower boiling compounds. High-viscosity oil and solidified wax and pitch material will inhibit proper operation of the condensation equipment and can interfere with the efficient recovery of lower boiling compounds; (d) The recovered coal-tar-oil can profitably be split into 2-5 fractions with different boiling ranges depending on the feedstock and oil yield, the fractionation can be made after the oil recovery, of course, but it is advantageous to do it directly at the stage of the oil recovery from pyrolysis vapor effluent; (e) The coal-tar-oil fractions can profitably be hydrotreated into (SCO) synthetic crude oil by means of high pressure and medium temperature catalytic addition of hydrogen.

In a first aspect of present invention, a process for recovering oil from pyrolysis vapor phase produced during mild temperature pyrolysis of a low rank coal by simultaneous fractionation of coal-tar-oil liquids is provided. The method comprising: extracting the coal-tar-oil in vapor phase as one of the end-product of mild temperature pyrolysis process of a low rank coal using a sweeping gas; optimizing the recovered coal-tar-oil from the vapor phase and reduced the amounts of non-condensing gas compounds by sequentially passing the high temperature vapor phase through a plurality of vapor condensing unit such that each vapor condensing unit operates at a defined temperature which is lower than the temperature in preceding vapor condensing unit to condense a fraction of coal-tar-oil liquid; wherein each sequential vapor condensing unit separates a different fraction of the coal-tar-oil liquid which has a condensing point within the operating temperature range of corresponding vapor condensing unit.

The vapor phase is recovered and condensed into several fractions by means of contacting the uncondensed vapors sequentially with product condensate-recycle streams cooled stepwise to a lower temperature in order to obtain in each step a predetermined condensation temperature and liquid product quality, and where the condensation temperatures are in the ranges of 750-850° F., 625-700° F., 425-675° F., 235-265° F. and 110-145° F.; and preferentially 825-850° F., 645-665° F., 440-460° F., 245-255° F. and 110-130° F., or more preferentially 845° F., 650° F., 450° F., 250° F. and 120° F. The low rank coal used for mild temperature pyrolysis process is low-sulfur LRC meeting the designation of sub-bituminous coal A, B or C or lignite generally characterized as having heating values below 9000-Btu/lb, water content above 25 w %, volatile matter content above 28 w %, and sulfur content below 1.4 w %. The mild temperature pyrolysis is conducted at a temperature below 1150° F. in the presence of the sweeping gas. The sweeping gas is used as a means to provide direct heating gas to volatilize and remove volatile matter, and where the weight ratio of sweeping gas to feed-coal is maintained below 2.0 and preferably below 1.5. In the mild temperature pyrolysis of low rank coal, the maximum operating temperature, sweeping gas space velocity and residence time at maximum temperature are adjusted so that the volatile material remaining in a coal-char is at least 13 w %, and the volatile material recovered from the LRC is limited to 7-21 w % of the LRC low rank coal.

The coal-tar-oil vapor phase contains the volatile material which is then recovered and simultaneously fractionated into the plurality of oil fractions. In each of the vapor condensing unit, the vapor phase is contacted with a condensed liquid material in a quench column followed by a surface-contact packing for condensation and droplet agglomeration. The condensed liquid material is circulated through a heat exchanger where it is cooled to attain the temperature of the corresponding vapor condensing unit and is recycled back into the quench column. The condensed fraction of coal-tar oil is removed from the vapor condensing unit for downstream processing. The plurality of vapor condensing unit operates at different temperature. For instance the vapor condensing units are operating at above 650° F., 450° F. to 650° F., 250° F. to 450° F., 130° F. to 250° F.

The fraction of coal-tar-oil condensed form the vapor condensing unit operating at temperature within 450° F. to 650° F., is further treated to remove coal fines by using cyclone separators, filtration or a combination thereof. The different fraction of coal-tar-oil derived from each of the plurality of vapor condensing unit are further fractionated into separate sub-fractions of polar compounds and non-polar compounds and wherein the non-polar compounds are refined into a syncrude oil refinery feedstock fraction, one or more wax fractions, and an electrode-binder-pitch feedstock fraction.

In a second aspect of present invention, a system for recovering oil fractions from pyrolysis vapor effluent produced during mild temperature pyrolysis of a low rank coal is provided. The system comprising: a pyrolysis system for producing a coal-tar-oil vapor effluent phase as one of the end-product of mild temperature pyrolysis process of a low rank coal using a sweeping gas; a plurality of vapor condensing unit arranged sequentially for optimizing the recovered coal-tar-oil from the vapor phase and reducing the amounts of non-condensing gas compounds in the vapor effluent, each of the said plurality of vapor condensing unit operates at a temperature lower than the preceding vapor condensing unit; wherein the vapor condensing unit comprises a condensed liquid material that when contacts with the vapor effluents condensed the uncondensed vapor present in the vapor effluent which has a condensation point equivalent to the corresponding vapor condensing unit.

The mild temperature pyrolysis is conducted at a temperature below 1150° F. in the presence of the sweeping gas. In the mild temperature pyrolysis of low rank coal, the maximum operating temperature, sweeping gas space velocity and residence time at maximum temperature are adjusted so that the volatile material remaining in a coal-char is at least 13 w %, and the volatile material recovered from the LRC is limited to 7-21 w % of the LRC low rank coal. In each of the vapor condensing unit, the vapor phase is contacted with a condensed liquid material in a quench column followed by a surface-contact packing for condensation and droplet agglomeration. The condensed liquid material is circulated through a heat exchanger where it is cooled to attain the temperature of the corresponding vapor condensing unit and is recycled back into the quench column. The condensed fraction of coal-tar oil is removed from the vapor condensing unit for downstream processing. The condensation temperatures are in the ranges of 750-850° F., 625-700° F., 425-675° F., 235-265° F. and 110-145° F.; and preferentially 825-850° F., 645-665° F., 440-460° F., 245-255° F. and 110-130° F., or more preferentially 845° F., 650° F., 450° F., 250° F. and 120° F. The plurality of vapor condensing unit operates at different temperature. For instance the vapor condensing units are operating at above 650° F., 450° F. to 650° F., 250° F. to 450° F., 130° F. to 250° F.

The fraction of coal-tar-oil condensed form the vapor condensing unit operating at temperature within 450° F. to 650° F., is further treated to remove coal fines by using cyclone separators, filtration or a combination thereof. The different fraction of coal-tar-oil derived from each of the plurality of vapor condensing unit are further fractionated into separate sub-fractions of polar compounds and non-polar compounds and wherein the non-polar compounds are refined into a syncrude oil refinery feedstock fraction, one or more wax fractions, and an electrode-binder-pitch feedstock fraction.

### BRIEF DESCRIPTION OF THE DRAWINGS

As can be readily understood by those skilled in the art, the process vessels used in the pyrolysis effluent oil-recovery condensation process herein described may be separate units or joined together in a single segmented shell unit depending on the plant design capacity, the equipment dimensions and the installed cost. The schematic drawings presented as FIGS. 1, 2, 3, and 4 illustrate one embodiment of the process equipment and mass flows.

FIG. 1 shows a Mild Temperature Pyrolysis process for converting a low ranking coal into a coal-char product, a coal-tar-oil (vapor phase) and pyrolysis gas in accordance with an embodiment of the present invention.

FIG. 2 illustrates a process flow diagram showing mass flow of coal-tar-oil vapor phase through a plurality of vapor condensing unit, for recovering fractions of oil, in accordance with an embodiment of present invention.

FIG. 3 is a schematic illustration of a vapor condensing unit showing flow of coal-tar-oil vapor phase in a vapor condensing unit in accordance with an embodiment of present invention.

FIG. 4 illustrates a plurality of vapor condensing unit processing the coal-tar-oil liquid in stepwise manner, in accordance with an embodiment of present invention.

FIG. 5 illustrates a multiple fraction vapor condensing unit having two units of quench separation, in accordance with an embodiment of present invention.

FIG. 6 illustrates the recovery process for recovering coal-tar oil fractions for downstream processing of different fractions obtained from coal-tar-oil or entire coal-tar-oil in accordance with an embodiment of present invention.

FIG. 7 illustrates a hydrotreating process for downstream processing of different fractions obtained from coal-tar-oil or entire coal-tar-oil in accordance with an embodiment of present invention.

### DETAILED DESCRIPTION OF THE INVENTION

In the following detailed description of embodiments of the invention, numerous specific details such as specific process steps, processing conditions, processing equipment, apparatus, and operating features are set forth in order to provide a systematic understanding of the invention. However, it is to be clearly understood by those skilled in the art that these are merely exemplary of the invention and are given to disclose the invention in the best embodiment presently contemplated by the inventor, and do not in any sense constitute a limitation upon the invention. This is particularly so with respect to the equipment and apparatus, since many functional variations can be used to carry out the invention, as will be appreciated by those skilled in the art.

Furthermore, it will be clear that the invention is not limited to these embodiments only. Numerous modifications, changes, variations, substitutions and equivalents will be apparent to those skilled in the art, without parting from the spirit and scope of the invention.

In order to overcome the disadvantages associated with prior art, the present invention provides a multi-step coal-tar-oil recovery process. The recovery process for the coal-tar gas and liquid fractions is specially designed with the following goals in mind: (a) Optimize the recovered coal-tar-oil from the pyrolysis vapor effluent and reduce the amounts of non-recovered condensable compounds in the gas; (b) Produce several separate liquid fractions during the recovery process; (c) In order to avoid deposits of high-viscosity wax and pitch material on the colder heat exchange surfaces required for condensation of the lower boiling hydrocarbon compounds, the high boiling compounds need to be recovered and separated at higher temperatures; (d) Optimize the temperature and heat content of recoverable waste heat for process utilization; (e) Reduction and optimization of operating cost including downstream processing cost and minimization of the overall capital cost; (f) Separation of coal-fines from the condensed coal-tar liquid fractions that contain reactive compounds that have affinity for activated carbon catalyzed polymerization at ambient temperature. The preferred process configuration and operating conditions are described in the following without limiting the present invention to the specific examples used to illustrate the process design.

The present invention is directed specifically to oil products derived from a mild temperature pyrolysis process for treating a low rank coal. As can be appreciated by those skilled in the art of coal pyrolysis, the mild temperature pyrolysis [MTP] gasification process for the formation of char and pyrolysis oil starts with a non-caking, non-coking coal and differs substantially from a process utilized for the formation of metallurgical coke. An important difference of this invention is the operability of a mild temperature pyrolysis process with the ability to control the temperature and composition of the pyrolysis gas in order to also provide precise control over the residual volatile content of the coal-char formed.

Although, high-temperature pyrolysis is widely used to produce metallurgical coke and coal-tar, these processes differ significantly from mild-temperature pyrolysis in design, operating conditions, coke product properties, coal-tar yield, composition and properties, and feedstock criteria. The yield and composition of high-temperature coal-tar have limited its value so that it has remained confined to being a byproduct. In contrast, due to the higher oil yield and quality, the coal-tar-oil product from mild-temperature pyrolysis [MTP] of low rank coal (LRC) can become the economic justification for development of commercial scale coal conversion projects based on the subject invention. By utilizing the present invention, the development of a coal conversion industry producing coal-char fuel, coal-tar-syncrude and coal-tar chemicals becomes technical feasible and economically viable. The present invention is useful because it provides a means whereby more than 75%, 85% or even 95% of the condensable coal-tar-oil contained in the diluted pyrolysis gas effluent from the mild-temperature pyrolysis reactor can be recovered in liquid form. The liquid oil can then be subjected to downstream processing and utilization instead of defaulting to fuel gas use. The economic value is potentially significant because the yield of recovered oil determines the economic viability of mild-temperature pyrolysis processing on low-rank coal.

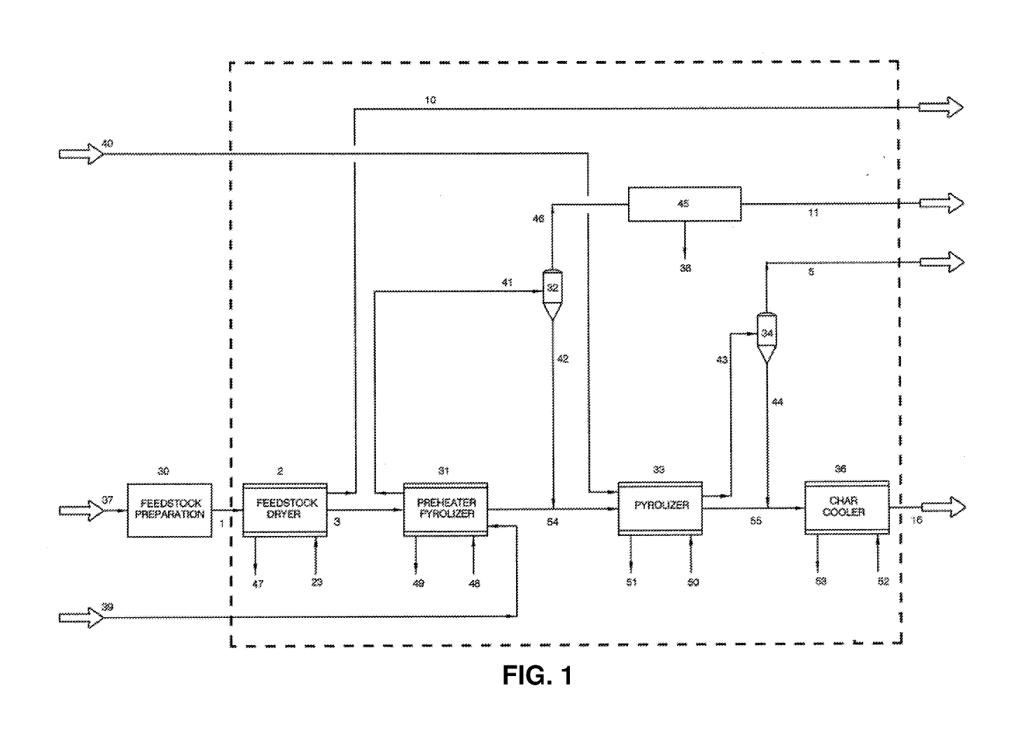

FIG. 1 shows a Mild Temperature Pyrolysis process for converting a low ranking coal into a coal-char product, a coal-tar-oil (vapor phase) and pyrolysis gas in accordance with an embodiment of the present invention. The feedstock preparation unit [30] provides for screening, milling and weighing of feedstock [37] before it is conveyed into the drier [2] where it is heated and most of the water is vaporized [10] using steam [23] recovered from the downstream process units that exits as recycle condensate [47]. The dried feedstock [3] is fed into the preheater-pyrolysis kiln [31] which is heated in part with indirect heating medium [48, exiting 49] provided to the outside of the kiln, and in part with a direct-contact hot gas stream [39] that flows through the kiln and exits as process off-gas [41]. This process off-gas [41] contains some amount of coal-fines and most of the mercury in the coal, and it is therefore passed through a cyclone [32] for coal-fines separation and recycle [42] and an absorber [45] for recovery of mercury [38] before the off-gas [11] flows to gas treatment. The preheated feedstock [54] exiting the pre-heater pyrolysis kiln [31] feeds into the high temperature pyrolysis kiln [33] which is heated in part with indirect heating medium [50, exiting 51] provided to the outside shell of the kiln, and in part with a direct-contact hot gas stream [40] that flows through the kiln and exits as high-temperature pyrolysis gas [43]. The pyrolysis gas [43] is passed through a cyclone [34] for separation of recycle coal-fines [44] and pyrolysis gas [5] that flows to the oil recovery unit. The hot coal-char [55] exiting the pyrolysis kiln [33] feeds directly into the char cooler [36] that is provided with indirect cooling medium [52, exits 53] for heat recovery and cools the coal-char product [16] for pyrite removal [17] and stabilization [19]. The mild temperature pyrolysis process is described in details in co-pending non-provisional application that contain priority from provisional application No. 62/601,521, the content of which is hereby incorporated in reference to its entirety.

In the MTP process the coal-tar-oil compounds are produced by mild-temperature pyrolysis and volatilized by the interaction between the elevated operating temperature, reaction residence time at temperature and the amount and space velocity of a “sweeping gas”. The pyrolysis takes place at 450-1200° F. with 15-45-minutes residence time. The sweeping gas has several separate and important functions in the process, since it is used simultaneously as a heating medium for the pyrolysis, to decrease the partial pressures of the compounds and help vaporize the coal-tar-oil, to help dilute the vapor phase and thereby decreasing the polymerization of reactive coal-tar compounds, and to help transport the coal-tar vapors out of the reactor. Sweeping gas must be inert, containing nitrogen, carbon dioxide, carbon monoxide, water and argon, but less than 1.5-vol % oxygen, preferably less than 0.5 w %; however, it also may contain traces of light hydrocarbons. It is desirable that the ratio of coal-tar-oil to sweeping gas is larger than 10-w %, preferably larger than 20%, although 4.5-6.5% is still operable, but less desirable because the lower concentration inhibits the recovery process and increases its efficiency and cost. Substituting part of the direct heating of the pyrolysis reactor with indirect heating results in decreased heating-gas requirements and higher coal-tar-oil concentration in the effluent.

The pyrolysis vapor phase effluent contains non-condensing gas compounds, including H2S, COS, CH4, C2H6 and homologues hydrocarbons together with sweeping gas and condensable oil compounds. The condensable fraction of the crude coal-tar has a boiling range of 200° F.-1400° F. The volatilization of compounds boiling above the 1200° F. upper pyrolysis temperature is due to the relatively low partial pressure of the individual components, the presence of sweeping gas and the effect of co-distillation with other compounds.

The present invention provides a method and a system for recovering different fractions of syncrude oil from the coal-tar-oil derived from the mild temperature pyrolysis process. The method involves utilizing several sequential coal-tar recovery process steps that separate the pyrolysis vapor effluent into three or more separate process streams including a non-condensed gas stream. The pyrolysis vapor effluent stream coming from the MTP process is at temperature above 1100° F., in which the oil vapors are present with different gases due to high temperature of effluent gas. The coal-tar oil contains different fractions that can be used for extracting the coal tar products which have variable economic importance. These fractions have different condensation point, which means the vapor phase can be condensed at different temperature to extract different fractions of coal-tar-oil. The present invention utilizes a plurality of vapor condensing unit arranged sequentially such that the pyrolysis vapor effluent from MTP first enters into a first vapor condensing unit operating at a specified temperature range. The fraction of oil which has a condensation point in this range get condensed in the first vapor condensing unit. The vapor effluent is then passed into a second vapor condensing unit operating at a second temperature range which is lower than the first vapor condensing unit. The fraction of coal-tar-oil which has condensation point in this range gets condensed and is then separated from the vapor effluent. This method is then performed in stepwise manner, such that each succeeding vapor condensing unit is operating at a temperature which is lower than the preceding vapor condensing unit.

The following example illustrates the process design, without thereby intending in any way to limit the number of separate liquid fractions that can be obtained. In this example the pyrolysis vapor is recovered and separated into five fractions: [1] Fraction-A, 650+° F.; [2] Fraction-B, 450-650° F.; [3] Fraction-C, 250-450° F.; [4] a mostly water Fraction-D at 135° F., [5] and a gas stream E, as described below.

Condensation of Fraction A, 650+° F.: The vapor phase effluent from pyrolysis is contacted with a recycle of the condensed liquid material in a quench column containing a combination of one or several spray-decks for initial gas/liquid contact followed by a surface-contact packing for condensation and droplet agglomeration. The recycle liquid exits the bottom of the quench column, passes through a heat exchanger where it is cooled so that the resulting vapor quench temperature is reached, passes through the recycle pump, and a side stream removes product [with level control from the column bottoms]. The recycle is then split into two, one going to the spray-deck sections and the other going to the top of the top of the contact-packing section. The 650+° F. fraction comprises approximately 45-55 w % of the condensable recovered pyrolysis coal-tar oil yield.

Recovery of Fraction B, 450-650° F.: The process is as described above for the gas-quench, except that the operating temperatures are 200° F. lower in order to condense the 450° F. fraction, which comprise 25-35 w % of the total recovered oil yield.

Recovery of Fraction C, 250-450° F.: The process is as described above, except that the operating temperatures are 200° F. lower in order to condense the 250° F. fraction, which comprise 5-15 w % of the total recovered oil yield.

Gas scrubbing to 135° F. [nominal temperature]: Recovery and separation of Fractions D, 135-250° F. and gas stream E. The vapor phase from the 250° F.-quench is cooled and water washed in a water-scrubbing column to recover water and any condensable material. The bottom liquid separates into an oil phase and a water phase that are withdrawn separately for further processing. Only the water phase is used as recycle to the gas scrubber. The gas phase exiting the top of the wash column is a lean fuel gas that will be used as process recycle sweeping gas [see above] and, after cleaning to remove source emissions, as fuel for the process heaters. For example, a plurality of vapor condensing unit are arranged sequentially such that the vapor condensing unit is operated in any of the following temperature range: 750-850° F., 625-700° F., 425-675° F., 235-265° F. and 110-145° F.; and preferentially 825-850° F., 645-665° F., 440-460° F., 245-255° F. and 110-130° F., or more preferentially 845° F., 650° F., 450° F., 250° F. and 120° F.

In an embodiment of present invention, the Coal-fines are removed from coal-tar-oil fractions to help the downstream processing of coal tar fraction. The removal of coal-fines, which essentially comprise activated carbon with catalytic properties, from the 450-650° F. oil fraction is important to prevent polymerization and instability of the chemically reactive polar compounds. This can be accomplished by several means, including using cyclone separators for the incoming vapor phase, cyclone separation or filtration of the condensed liquid, or a combination thereof. When gas-phase cyclone separation is used, sufficient pressure to overcome the associated pressure drop will have to be provided by means of higher upstream operating pressure or using a low-pressure compressor. When coal-fines removal from the liquid oil phase is employed a combination of cyclone separation and a series of filters of decreasing fineness may be most suitable and cost effective depending of the MTP design and the characteristics of the feed-coal.

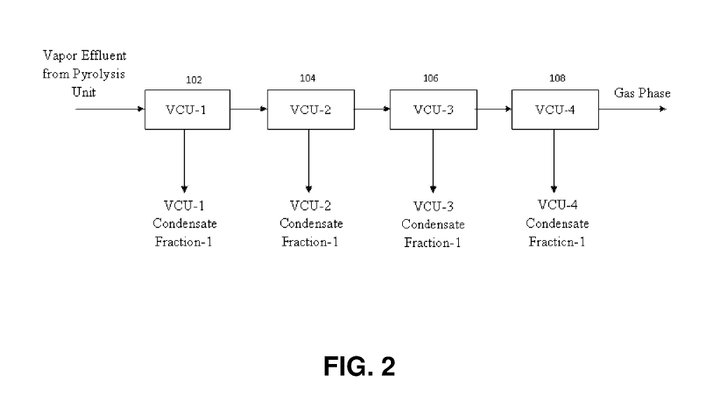

FIG. 2 illustrates a process flow diagram showing mass flow of coal-tar-oil vapor phase through a plurality of vapor condensing unit, for recovering fractions of oil, in accordance with an embodiment of present invention. There are four vapor condensing unit (VCU) that are arranged sequentially to recover a fraction of coal-tar-oil. The high temperature vapor effluent from pyrolysis unit is passed through a first vapor condensing unit. The vapor effluent from the pyrolysis unit is at high temperature, which is in range of 950-1050° F. Due to the high temperature, the coal-tar-oil is in vapor phase intermixed with different gases. The first vapor condensing unit is operating at a temperature which is lower than the vapor effluent stream. A condensing liquid or gas is present in the first condensing unit, such that the vapor effluent from the pyrolysis kiln is contacted with the condensing liquid or gas at a heat exchanger surface, and on the contact with heat exchanger at a lower temperature, a fraction of coal-tar-oil gets condensed which can then be recovered from the bottom of the first vapor condensing unit. For illustration purpose, the first vapor condensing unit of FIG. 1 is operating at a temperature above 600° F. The condensate from the first vapor condensing unit is then pumped to a system where the downstream processing of this fraction condensate is performed to sub-fractionate and refinement of the first condensate fraction.

The remaining vapor effluent is then passed through a second vapor condensing unit, which also contains a condensate liquid or gas, a heat exchanger. The second vapor condensing unit is operating at a temperature lower than the first vapor condensate. For example, in case of FIG. 1, the second vapor condensing unit is design to condensate the fraction within a temperature range of 450-600° F. The temperature of the second condensing unit is lower than the first condensing unit, therefore, when the vapor effluent from the first vapor condensing unit passes through the second condensing unit, the fraction of oil which has a condensing point within the operating temperature range of 450-600° F. gets condensed and then collected through the bottom of the second vapor condensing unit. The second condensate fraction is then pumped to undergo downstream processing for sub-fractionation and refining.

The vapor effluent from the second condensing unit is then passed through a third vapor condensing unit which is similar in structure to the first vapor condensing unit and the second vapor condensing unit. The operating temperature of the third vapor condensing unit is lower than the first vapor condensing unit and the second vapor condensing unit. The vapor effluent when contacted with the condensing media, results in the condensation of oil fraction which has a condensation point within the operating range of the third vapor condensing unit. For illustration purpose, the third vapor condensing unit is operating at a temperature range of 300-450° F. The condensed fraction is collected from the bottom of the third vapor condensing unit.

The vapor effluent from the third vapor condensing unit is then passed through a fourth vapor condensing unit, which is operating at a temperature lower than the third vapor condensing unit. For illustration, the fourth vapor condensing unit is operating at a temperature range of 135-300° F. The vapor phase contacting the quench get cooled and withdrawn from bottom for further processing. The gas phase exiting the top of the wash column is a lean fuel gas that will be used as process recycle sweeping gas and, after cleaning to remove source emissions, as fuel for the process heaters

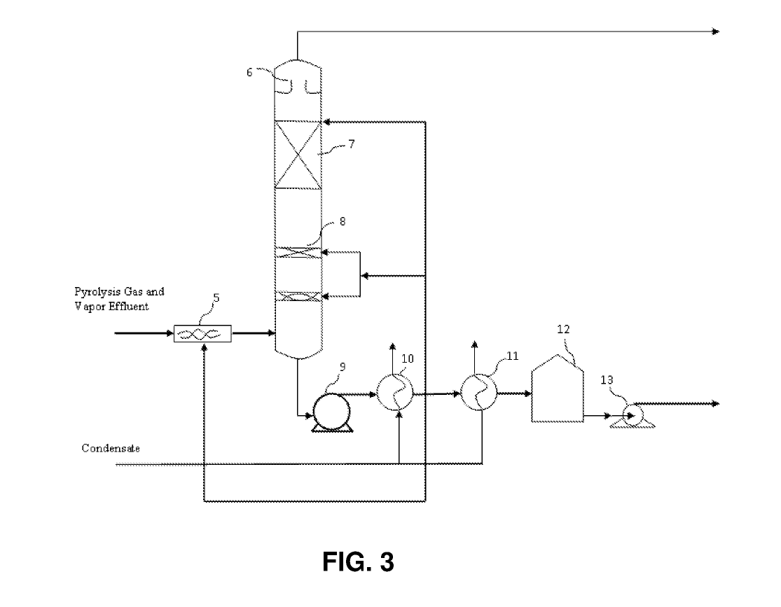

FIG. 3 is a schematic illustration of a vapor condensing unit showing flow of coal-tar-oil vapor phase in a vapor condensing unit in accordance with an embodiment of present invention. The vapor condensing unit comprises a Venturi gas/liquid mixer [5], a quench vessel [6], a packed section [7], a plurality of spray deck [8], a recycle pump [9], a first heat exchanger [10] and a second heat exchanger [11]. In an embodiment, each of the plurality of vapor condensing unit may be schematically identical or different, depending on the viscosity of the individual oil fractions separated by the particular vapor condensing unit. In another embodiment, the dimensions of equipments of each of the vapor condensing unit are different among vapor condensing unit, depending on the difference in temperature, gas volume being processed and liquid product collected.

In the Venturi gas/liquid mixture [5], the pyrolysis gas and vapor effluent coming from the pyrolysis kiln is mixed with a stream of condensed liquid such that the mixture of vapor effluent and liquid stream reach the desired condensing temperature. The desired temperature stream of condensed liquid by cooling the liquid stream by the first heat exchanger [10] to a lower temperature so that the mixture of vapor effluent and the liquid reach the desired condensing temperature. The condensing stream of liquid is pumped through the recycle pump 9. The quenching of vapor effluent and liquid mixture will take place at the quench vessel [6]. The quench vessel [6] has a plurality of spray decks [8] through which condensed liquid is sprayed on the vapor effluent/condensed liquid mixture coming from the Venturi gas/liquid mixture. The upper part of quench vessel [6] has a packed section [7] that serves as a thermal stabilizer and a means to coalesce escaping droplets. The packed section [7] is at a sufficient height from the plurality of spray decks [8] such that the highest boiler fractions get condensed en route between the Venturi mixer and the plurality of spray decks, which prevent the upper packed section to get clogged by condensed particles. The spray decks are in relatively open configuration that also prevents the clogging of packed section.

The process flow in the vapor condensing unit starts with mixing of vapor effluents with the liquid condensed material which drops the temperature of vapor effluent to condensation point. The resulting mixture then travels to quench vessel [6] where the condensed liquid is sprayed over the incoming mixture to help condensation of fraction of coal-tar-oil. The remaining vapor pass form the top of quench vessel [6] to next vapor condensing unit for further processing. The condensed fraction of coal-tar-oil along with the condensed liquid passed through the bottom of quench vessel. The recycle pump [9] pumps the condensed fraction and liquid to the first heat exchanger [10] where the fraction is cooled to the desired temperature and thus recycling of condensed liquid takes place. The cooled condensed liquid and fraction of coal-tar oil is then used for cooling the incoming vapor effluents in Venturi mixer and plurality of spray deck. From this recycle stream, a side stream of product is withdrawn and cooled by the second heat exchanger [11]. This is the fraction of oil that is recovered from the vapor condensing unit. The recovered oil fraction is then stored in a storage tank [12] which is then pumped by a pump [13] for downstream processing. The heat generated by the first heat exchanger [10] and the second heat exchanger [11] can be utilized for heating process either in mild temperature pyrolysis or other process. Thus, by using the process of present invention, it is possible to recover heat from the first heat exchanger [10] and the second heat exchanger [11].

In an embodiment, the present invention utilizes a plurality of vapor condensing unit operating at different temperature range for condensing oil fraction, wherein each sequential vapor condensing unit is operation at a temperature lower than the previous vapor condensing unit.

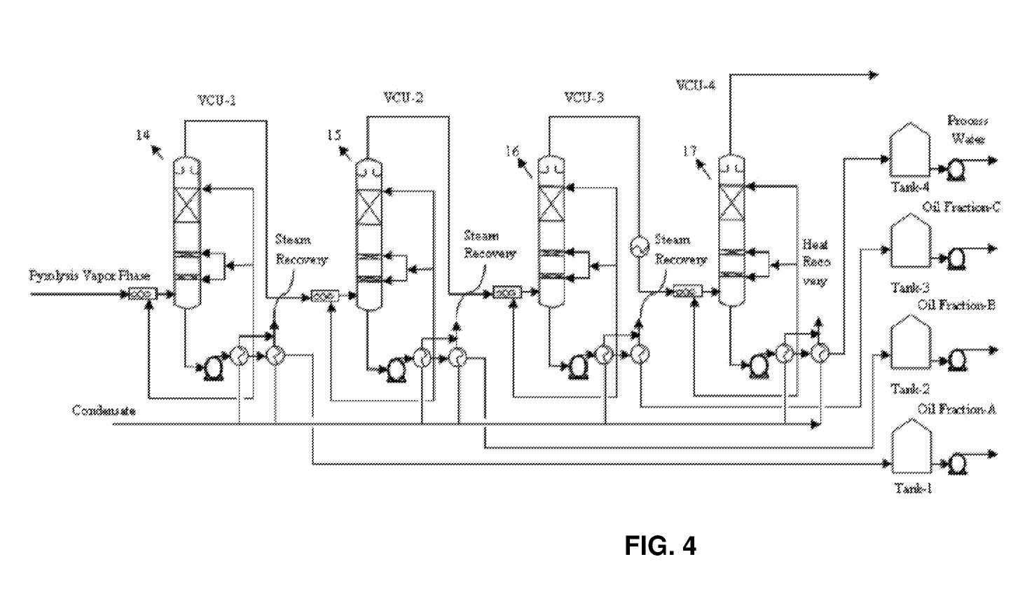

FIG. 4 illustrates a plurality of vapor condensing unit processing the coal-tar-oil liquid in stepwise manner, in accordance with an embodiment of present invention. FIG. 4 shows a first vapor condensing unit [14], a second vapor condensing unit [15], a third vapor condensing unit [16] and a fourth vapor condensing unit [17] arranged in a sequence to process the vapor effluent stream coming from the pyrolysis kiln. The operating condensing temperature of the fourth vapor condensing unit is lower than the operation condensing temperature of the third vapor condensing unit, which in turn is lower than the operating condensing temperature of the second vapor condensing unit, which in turn is lower than the operating condensing temperature of the first vapor condensing unit. Due to the difference in operating condensing temperature, the rating of equipments and the design of these vapor condensing units may be identical or different. The vapor effluent from the pyrolysis kiln is entered into the first vapor condensing unit [14]. The vapor effluent is mixed with the condensed liquid in the Venturi mixer of the first vapor condensing unit and is then passed through the quench vessel, where the condensed liquid is sprayed on the vapor effluent/condensed liquid mixture. The condensation takes place and the condensed mixture is collected from the bottom of the first vapor condensing unit. A stream of product is removed from the condensed liquid obtained from the first vapor condensing unit and is transported to a storage tank for storing first fraction. The rest of the condensed liquid/fraction mixture is recycled to use for next stream of vapor effluent. In the first vapor condensing unit only that fraction of coal-tar-oil that has a condensation point within the operating range of the first condensing unit gets condensed, and the remaining vapor effluent pass from the top of the first vapor condensing unit to the second condensing unit. In the second condensing unit, same process is repeating and a second fraction of oil is recovered from the vapor effluent that has condensation temperature lower than the first vapor condensing unit. The second fraction of recovered coal-tar-oil is then stored in a second storage tank.

The remaining vapor effluent from the second condensing unit then passes to the third vapor condensing unit which condenses the fraction of coal-tar-oil that has condensation temperature lower than the second vapor condensing unit. The fraction obtained from the third vapor condensing unit is stored in a third storage tank.

The remaining vapor effluents from the third vapor condensing unit [16] is then passed to the fourth condensing unit [17], where the fourth fraction of coal-tar-oil is recovered and stored in a fourth storage tank. The remaining vapor effluent contains primarily contain non-condensable gas fraction which can then either be used as a fuel or in the pyrolysis process itself.

The example in FIG. 4 is for mere illustrative purpose, whereas in embodiment, the present invention utilizes a plurality of vapor condensing unit, which may be two to more than six vapor condensing units.

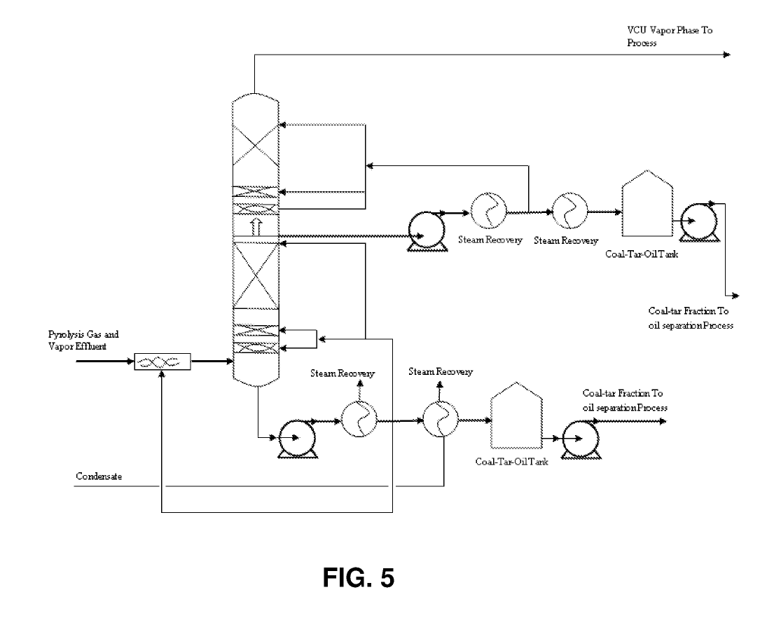

In an embodiment of present invention, it is envisioned that the design of a vapor condensing unit used in the present invention can be modified to include one or more vapor condensing unit in a single vessel. The two or more vapor condensing units are connected by a chimney tray that allows the vapor effluent in gas phase to flow up from the lower quench vessel to the next upper quench vessel. The vapor effluents from pyrolysis kiln enter into a Venturi mixer where it is mixed with a liquid condensed material and enters into the vessel. The vessel in FIG. 5 contains two vapor condensing unit stacked one over another separated by a chimney tray. The mixture of vapor effluent and the condensed liquid enter into the first vapor condensing unit where condensation of first fraction of coal-tar oil takes place. The remaining vapor effluents then enter into the second vapor condensing unit which is present in the same vessel. The condensation of second fraction of coal-tar-oil is recovered from the second vapor condensing unit.

FIG. 5 illustrates how the stacking of one vapor condensing unit on top of the next can provide savings in equipment and piping cost. In an embodiment, any reasonable number of VCUs can be joined in this manner depending on cost limitations associated with the vessel dimensions, except if vapor cyclones are installed between quench vessels to separate gas from coal-fines and/or oil droplets.

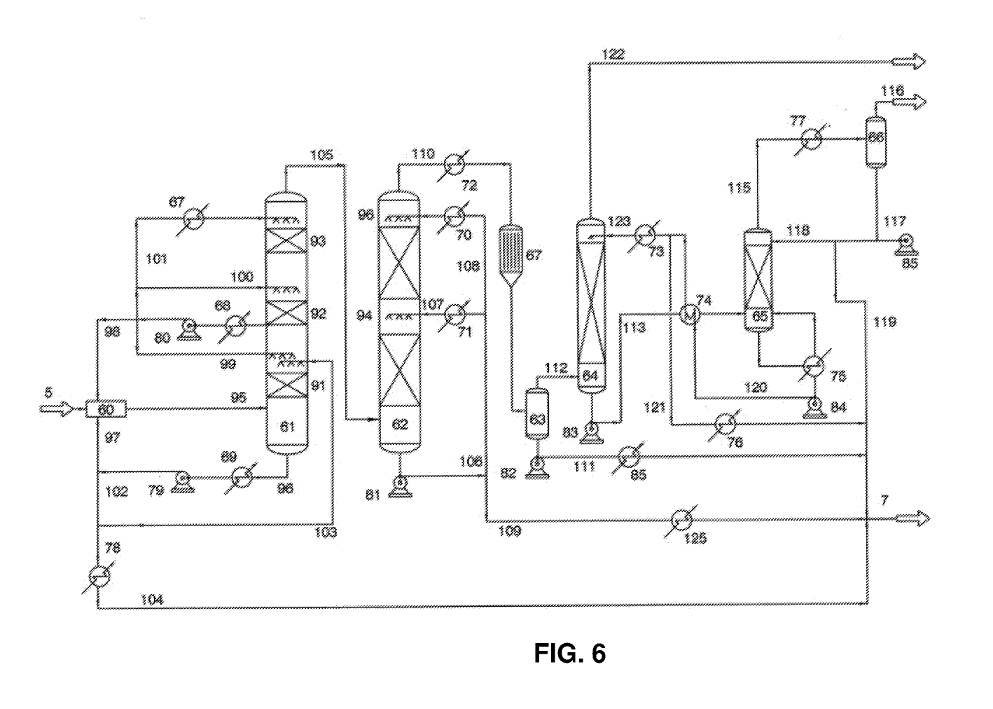

FIG. 6 illustrates the recovery process for recovering coal-tar oil fractions for downstream processing of different fractions obtained from coal-tar-oil or entire coal-tar-oil in accordance with an embodiment of present invention. The vapor condensing unit comprises a hot pyrolysis gas and oil vapor stream [5] exiting the pyrolysis unit at 900-1100° F. flows into a Venturi-mixing quench device [60] and mixes with two cooled recycle oil streams [97 and 98] from the first absorber vessel [61], reducing the temperature of the gas/oil mixture [95] to below the oil cracking range as it exits the quench device and enters the absorber vessel [61]. The uncondensed gas/vapor pass upward through a quench spray-deck section [91] in contact with downwards flow of oil pumped from the vessel bottom through a pump [79] and heat exchanger cooler [69] to spray nozzles placed above the spray-deck and mixing with oil from the mid-section of the vessel flowing through a pump [80] and heat exchanger cooler [68] to spray nozzles placed above the spray-deck. Two similar absorber sections [92 and 93] are placed above the first with separate coolers [67 and 68] to control the operating temperatures as required to obtain the desired composition of the exit gas/vapor phase stream [105]. The condensed oil fraction [96] exiting at the bottom of the first absorber vessel [61] flows through a cooler [69] to a pump [79] and splits into a first recycle stream [97] going to the gas-quench mixer [60], a second recycle stream [103] going to the first spray-deck, and a third stream [104] passing through a heat exchanger cooler [78] and joining with the other oil fractions going to hydrotreating [7]. The overhead gas phase [105] from the absorber vessel [61] flows to the second absorber vessel [62] where the oil condensation and fractionation process is repeated at lower temperatures employing two cooled oil recycle loops [106 and 108] with a pump [81] and two heat exchanger coolers [70 and 71] to produce a second condensed oil fraction [109] that is cooled in heat exchange [125] and then joins the oil feed stream [7] going to hydrotreating. The uncondensed gas phase [110] exiting from the top of the absorber vessel [62] flows through a partial condenser [72], an electrostatic separator [67] for coalescing of oil-mist and a phase separation vessel [63] from where the third condensed oil fraction [111] flows through a pump [82] and a cooler [85] joining the oil feed stream [7] going to hydrotreating. The gas phase [112] flows to the third absorber vessel [64] where an oil fraction [113] is separated at the bottom and a gas stream [122] is removed at the top and conducted to the downstream gas and water separation and treatment unit. The condensed oil fraction [113] from the bottom of the vessel [64] flows through a pump [83] and a heat exchanger [74] to a distillation column [65] that is provided with a reboiler [75], condenser [77] and overhead separation vessel [66] where the non-condensable gas [116] is separated from the condensed light-end oil fraction [117] and flows to gas treatment [26], while the condensed oil fraction is pumped via pump [85] in part back as reflux [118] for vessel [65] and in part [119] joins the oil feed stream [7] going to hydrotreating. From the bottom of the distillation column [65] the oil fraction product [120] flows through a pump [84] and heat-exchanger [74], and then is split into a recycle stream [123] going to the top of the absorber vessel [64] and an oil stream [121] passing through a cooler [76] and joining the other recovered oil fractions [7] on the way to hydrotreating. The recovered oil fractions generally are not mixed until entering hydrotreating processing due to their different compositions, polarity, viscosity, density and solubility that in some cases may cause phase separation.

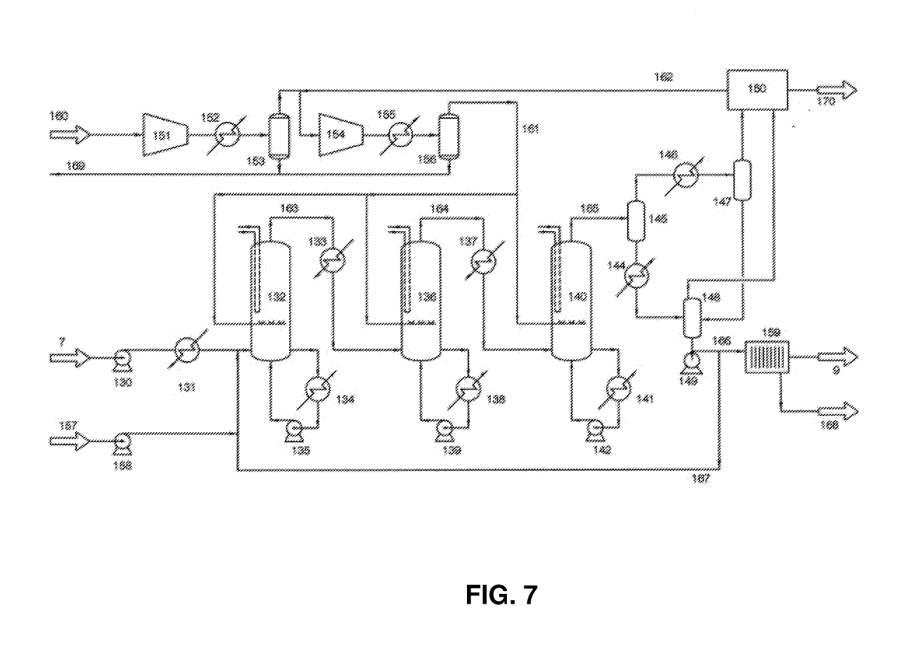

In an embodiment of present invention, the coal tar fractions is converted to synthetic crude oil by fixed bed catalytic hydrotreating process. FIG. 7 illustrates a hydrotreating process for downstream processing of different fractions obtained from coal-tar-oil or entire coal-tar-oil in accordance with an embodiment of present invention. FIG. 7 shows a preferred version of the oil hydrotreating section that reflects the large hydrogen demand by pyrolysis oil in the range of 55-kg/ton-oil (3000-SCF/bbl), the attendant large heat release and the need for stepwise reaction temperature increases for better control of the conversion of olefins, oxygenated compounds, aromatics and high molecular weight hydrocarbons. The reactor configuration features three ebullient-bed reactors [132, 136 and 140] in series. The oil feedstock [7] is comprised of the condensed oil fractions from the oil recovery and gas separation section and is introduced into the first reactor vessel [132] through a high-pressure pump [130] and heat exchanger [131]. The reactors are provided with a hydrogen supply [160] entering through a primary compressor unit [151] with inter-cooler [152] and a water separation vessel [153] that feeds into a secondary recycle compressor unit [154] with condenser [155] and separator vessel [156]. The high-pressure hydrogen [161] is delivered to the reactors [132, 136 and 140] through internal nozzles ensuring good internal mixing [ebullience] and circulation. The reactor [132] is cooled by means of recycle cooling media in contact with internal and external cooling surface areas as well as a process-oil recycle loop [cooler 134 and pump 135] providing temperature control and waste-heat recovery. The reactor effluent [163] is heated in a heat-exchanger [133] to the higher reaction temperature required in the next down-stream reactor. This sequence is repeated for the other reactors [136 and 140]. Fresh catalyst slurry [157] is introduced through a pump [158] into the catalyst recycle loop [167]. The effluent [165] from the last reactor [140] is separated into a liquid oil fraction and a hydrogen gas fraction through several steps of cooling [144, 146] and phase separations with pressure reduction and vapor/liquid-flash separations [145, 147, 148] of which two are shown schematically in this design case. The gas phase is further treated in a gas separation unit [150] to recover a fuel gas stream [170] and a hydrogen rich recycle stream [162] that returns back to the hydrogen recycle compressor [154]. The recovered oil phase [166] from separation vessel [148] contains catalyst slurry and is in part recycled through a pump [149] back to the hydrotreating reactor [132]. The balance of the oil is clarified in a filter [159] and exported as synthetic crude oil product [9] while the spent catalyst [168] is removed for disposal.

In an embodiment of present invention, the removal of the polar compounds [catechol, cresylic acid and N-bases fractions] from the coal-tar feedstock before undergoing mild temperature pyrolysis, results in significant savings in hydrogen consumption in the order of 15-30-%. Removal of the 900+° F. high boiling coal-tar-pitch fraction, which may have better use as electrode binder pitch or delayed-coke feedstock, also decreases the hydrotreating cost and increases the yields of desirable hydrocarbons. The coking process yields a light-cycle-oil that can be used as feedstock in the hydrotreater.

In another embodiment, an alternative to hydroterating at the above mentioned operating conditions, is applying a high-pressure process such as the HTI hydrotreating designed for coal conversion and using a homogeneous slurry catalyst and 3000-psia pressure of higher. In this case the presence in the recovered coal-tar-oil of 900+° F.-HT-pitch and coal-fines that tend to form deposits on fixed-bed catalysts, do not present unusual problems. Several similar alternative hydrotreating process are in operation on feedstock derived from tar-sand oil extraction, oilshale and coal-to-liquid, and the choice of process is an economic decision based on the cost, experience, feedstock quality, product slate and commercial warranties provided for each site specific project.

In an embodiment of present invention, the condensate from coal-tar-oil produced during the mild temperature pyrolysis of low-rank coal can be used to produce a wax. The high boiling condensate is collected and vacuum distilled to yield a bottoms material with a boiling point in excess of +550° F. This bottoms material is then diluted with N-Methylpyrrolidone (NMP) at ratios of 1:1 and 2:1 NMP to 550+ boiling fraction of the condensed material. While the 550+ bottoms material remains solid at 150° F. initially, with the addition of both 1:1 and 2:1 NMP to bottoms render it free flowing at temperatures as low as room temperature, transforming it into a useful low temperature extraction feed material, useful for counter current extraction.

This feed material is then extracted against various ratios of heptane to feed of 2:1 to 5:1, resulting in heptane soluble wax yields of 22% to 39% when extracted at 110° F., and wax yields of 26% to 44% when extracted at 160° F. The heptane is then stripped from the wax products by vacuum distillation and all of the resulting properties is found to be miscible with molten paraffin wax. The NMP diluant get mixed with the raffinate and does not contaminate the heptane extract or the wax, allowing for more than 99% recovery of the NMP from the raffinate, resulting in a commercially viable coal tar pitch.

In another embodiment, the 550+ bottoms feed is diluted with 2 parts NMP to 1 part of 550+ fraction condensate material and is then subsequently extracted against an excess of heptane 5 times, collecting the resulting wax materials with each extraction step. The properties of each sample are measured using Iatroscan, which reports the constituents in the broad categories of Saturates, Aromatics, Polars A and Polars B, which represent two molecular weight ranges of polar materials. Extractions is carried out at 110° F. and 160° F. with the wax yield data for each extraction appearing in the table A below, where the first 2 lines of data, SGITC 550+ and D100-1-4-T1-BT being feed materials, NMP being the diluant for the feed materials and almost totally polar, sample labels ending in C being extracted at 110° F. and those with labels ending in D being extracted at 160° F. and the last two lines being the wax products.

TABLE A

| | Satu- | Aro- | | | |
|---|---|---|---|---|---|
| Sample | rates | matics | Polars A | Polars B | (S + A): P |
| SGITC 550+ | 10 | 16 | 46 | 28 | 0.35 |
| D100-1-4-T1-BT | 8 | 16 | 51 | 25 | 0.32 |
| NMP | 0 | 0 | 93 | 7 | 0.00 |
| EX-1C | 21 | 35 | 32 | 12 | 1.27 |
| EX-2C | 13 | 40 | 38 | 9 | 1.13 |
| EX-3C | 7 | 42 | 40 | 11 | 0.96 |
| EX-4C | 4 | 40 | 43 | 13 | 0.79 |
| EX-5C | 0 | 35 | 51 | 14 | 0.54 |
| EX-1D | 22 | 37 | 31 | 10 | 1.44 |
| EX-2D | 16 | 43 | 32 | 9 | 1.44 |
| EX-3D | 9 | 35 | 42 | 14 | 0.79 |
| EX-4D | 2 | 43 | 41 | 14 | 0.82 |
| EX-5D | 3 | 42 | 40 | 15 | 0.82 |
| D100-1-6-BT-4A | 21 | 35 | 33 | 11 | 1.27 |
| D100-1-6-BT-4B | 21 | 37 | 33 | 9 | 1.38 |
| SGI Wax B | 19 | 31 | 43 | 7 | 1.00 |
| SGI Wax B Bau | 12 | 47 | 36 | 5 | 1.44 |

As can be seen by inspection of Table-A below, the extraction process results in a 3-4 fold increase in the (Saturates+Aromatics): Polars ratio, to the range of 1:1, creating a product with a high boiling point, and an almost equal affinity for polar and non-polar materials, and surprisingly, rendering it compatible with both. This material is tested and found to be commercially viable in a hard board manufacturing operation, having a lower emission profile during the high temperature press cure cycle than paraffin or slack wax, due to its higher boiling point. The coal derived wax was also shown, both in the laboratory and in the manufacturing operation to be completely miscible with petroleum waxes, so that it could be used in any ratio in the formulation. The properties of commercial waxes and this coal-derived wax are compared in Table-B below. This coal derived wax, +550 F wax—Treated and +550 F. wax—Un-Treated, is unique in as a coal derived wax in its difference from and compatibility with petroleum waxes and also, by inspection of the above table unique from the only known coal extracted wax which is Montan wax, and which is 99% polar in nature and not miscible with paraffin wax.

TABLE B
ADHESIVE WAX PROPERTIES

| | | +550 F. WAX | +550 F. WAX | COMMERCIAL WAXES | |
|---|---|---|---|---|---|
| | TEST METHOD | TREATED | UN-TREATED | PARAFFIN | MONTAN |
| Softening Point (deg. F.) | ASTM Ring & Ball | 86-99 | 71 | 124 | 167-176 |
| Acid Number | Proprietary | 8.1 | 11.0-16.1 | <0.5 | 22-36 |
| Saponification No. | Proprietary | 99.7 | 40.3-00.4 | 7.7 | 75-100 |
| Iodine No. | Proprietary | 79.3 | 63.0-75.3 | — | 16 |
| Boiling Range (% @ 550 deg. F.) | Proprietary | >90 | >90 | >90 | — |
| Oxygen (% w/w) | By difference | 4.39 | 3.56-5.15 | <0.5 | 6.8 |
| Saturates (% w/w) | latroscan | 12 | 15-20 | 93 | <1 |
| Aromatics (% w/w) | latroscan | 47 | 34-39 | 2 | 1 |
| Polars (% w/w) | latroscan | 41 | 43-51 | 5 | 99 |
| Miscable with molten Paraffin | Proprietary | YES | YES | YES | NO |

The balance in polar and non-polar properties suggest that this wax may form stable mixtures with adhesives, and may be formulated to chemically react with adhesives during the cure cycle as well, due to its reactivity which arises from the characteristics of mild temperature pyrolysis liquids, creating an new category of reactive waxes which function like reactive diluents imparting properties such as fracture toughness or surface sheen, and reduced cost to adhesive and coating formulations.

The following examples and numeric data are provided for the purpose of illustration and information without implying any limitations as to the process invention, the equipment or any other limitation with respect to the invention. The downstream processing of the recovered oil fractions will depend on market conditions including the relative values of the compounds contained in the oil. The pre-fractionation accomplished in the multi-stage quench-condensation process described herein facilitates the downstream processing and eliminates the need for a crude coal-tar-oil distillation plant. The following examples and data illustrate the range of compositions of the MTP coal-tar-oil, recovered oil fractions and functionality resulting from the process.

### Example-01 LRC MTP Crude Coal-Tar Properties

The vapor effluent from MTP processing was collected and condensed, and the vapor phase and liquid phase were analyzed by GC and converted to a single material balance. The material balance provides an example of the process when indirect heating with inert-gas recycle is provided as 100% of the thermal energy for pyrolysis. As demonstrated, this results in rather low concentration of condensable coal-tar-oil, in this example to just 4.7 w % organic material and 95.3 w % recycle-gas plus non-condensable fuel gas [note use of decimal rounding].

| | Component | Lb/h | Wt % |
|---|---|---|---|
| Non-condensable | CO | 487 | 0.23 |
| compounds | CO2 | 30,728 | 14.63 |
| | H2 | 2 | 0.001 |
| | H2S | 71 | 0.03 |
| | N2 | 119,341 | 56.83 |
| | NH3 | 241 | 0.11 |
| | Water | 46,649 | 22.2 |
| | SO2 | 138 | 0.07 |
| | Methane | 1579 | 0.75 |
| | Ethane | 386 | 0.18 |
| | C-3 | 283 | 0.13 |
| | C-4 | 210 | 0.1 |
| | C-5 | 130 | 0.06 |
| | Subtotal | 200,245 | 95.35 w % |
| Condensable | C-6 | 111 | 0.053% |
| Oils compounds | C-7 | 15 | 0.007% |
| | C-8 and C-9 | 30 | 0.014% |
| | C-10 and C-11 | 35 | 0.017% |
| | C-12 | 15 | 0.007% |
| | C-13 | 38 | 0.018% |
| | C-14 | 130 | 0.062% |
| | C-15 | 180 | 0.086% |
| | C-16 | 220 | 0.105% |
| | C-17 | 270 | 0.129% |
| | C-18 | 275 | 0.131% |
| | C-19 | 304 | 0.145% |
| | C-20 | 306 | 0.146% |
| | Phenol | 168 | 0.080% |
| | p-Cresol | 239 | 0.114% |
| | Et-phenol | 260 | 0.124% |
| | Pr-phenol | 210 | 0.100% |
| | Bu-phenol | 227 | 0.108% |
| | Naphthol | 115 | 0.055% |
| | Dibenzofurane | 15 | 0.007% |
| | Recisorcinol | 199 | 0.095% |
| | Ethylbenzene | 42 | 0.020% |
| | Me-naphthalene | 86 | 0.041% |
| | Et- naphthalene | 168 | 0.080% |
| | Benzol-naphthal. | 258 | 0.123% |
| | Phenanthrene | 115 | 0.055% |
| | Benzothiaphene | 21 | 0.010% |
| | Me-pyridine | 15 | 0.007% |
| | Indole | 157 | 0.075% |
| | BP-fraction 582-693° F. | 1,827 | 0.870% |
| | BP-fraction 693-783° F. | 1,764 | 0.840% |
| | BP-fraction 783-1303° F. | 1,936 | 0.922% |
| | Subtotal Liquid material | 9,755 | 4.7 w % |

| | | |
|---|---|---|
| Total gas and oil | 210,000 | 100.0% |

### Example-02, LRC MTP Crude Coal-Tar Properties

Sample of coal-tar-oil recovered from Wyoming sub-bituminous LRC MTP was fractionated by distillation and inspected for physical properties. The data indicates that at the pyrolysis operating conditions 15-20% of the light-end materials were not recovered because of low partial pressure and a low oil/inert-gas ratio of 4.5-6.0-w %. At room temperature the material separates into three separate liquid phases.

| | Total | | | | | |
|---|---|---|---|---|---|---|
| Oil Fraction | Sample | #1 | #2A | #2B | #3 | #4 |
| Physical properties | | | | | | |
| Distillation yield, w % | 100.00 | 9.4 | 3.2 | 28.7 | 16.6 | 42.1 |
| Boiling Range, F. | 185-1150 | IBP-450 | 450-550 | 550-650 | 650-900 | 900+ |
| Specific gravity, g/ml | 1.081 | N/A | 0.938 | 1.046 | 1.049 | 1.09 |
| API Gravity, 60° F. | 1-3 | 19.4 | 3.4 | | 3.4 | ~1.5 |
| Acid number, mgKOH/g | | N/A | 0.6 | 3.2 | 1.3 | 5.1 |
| Elemental analysis: wt % | | | | | | |
| Carbon | 79.5 | N/A | 82.7 | 78.3 | 83.4 | 83.2 |
| Hydrogen | 8.62 | | 10.5 | 8.6 | 9.7 | 7.8 |
| Oxygen (diff.) | 9.79 | | 4.2 | 11.2 | 6.1 | 7.4 |
| Nitrogen | 0.54 | | 0.22 | 0.49 | 0.35 | 0.47 |
| Sulfur | 0.52 | | 0.26 | 0.31 | 0.32 | 0.33 |
| Ash | nil | | — | — | — | — |

| | |
|---|---|
| H/C-molar-ratio | 8.62/[79.50/12] = 1.30 |
| Viscosity, 122° F., CS | 280 |
| Pour Point, F. | 66-90 |
| Flash Point, F. | 170-240 |
| Water, wt % | 1-2 |
| Sediment, wt % | 1-3 |
| Heating value, Btu/gal | 140,000 |

### Example-03, LRC MTP Crude Coal-Tar Distillation Fractions

Two different samples of coal-tar-oil recovered from Wyoming sub-bituminous LRC MTP was fractionated by distillation and inspected.

| | | | |
|---|---|---|---|
| I Distillation Fractions: | wt % | Sp. Gr. | Flash point |

| | | | | |
|---|---|---|---|---|
| 1 | IBP-450° F. | 9.4 | g/ml | COC, C |
| 2 | 450-650 | 31.9 | 1.090 | 171 |
| 3 | 650-900 | 16.6 | 1.117 | 237 |
| 4 | 901+ | 42.1 | 1.122 | 316 |

| | |
|---|---|
| Total | 100.00 |

II Distillation Fractions:

| Fraction IBP - 662° F. | | | w % |
|---|---|---|---|
| Compounds | Saturated HC | Aliphatic paraffins | 4.5 |
| | | Other saturated HC | 2.8 |
| | Aromatics | Monocyclic aromatics | 2.2 |
| | | Bicyclic aromatics | 3.2 |
| | | Tricyclic aromatics | 0.5 |
| | | Tetracyclic aromatics | 13.1 |
| | Polar | Phenol | 1.5 |
| | compounds | Cresols | 2.7 |
| | | Other phenols | 4.1 |
| | | Naphthols | 1.2 |
| | | Benzenediols | 7.8 |

| Subtotal | | 43.6 = 43.60 |
|---|---|---|
| Residual Fraction 662+° F. | Toluene-insoluble fraction | 14.63 |
| | Toluene-soluble fraction | 41.77 |

| | |
|---|---|
| Total | 100.00 |

### Example-04, Oil Fractions, Yields and Potential Downstream Processing

The fractionation provided as an integral part of the coal-tar-oil recovery process is motivated by the need for downstream separation into marketable fractions and the desire to decrease the cost of this separation. The following example serves to illustrate the pre-fractionation of pyrolysis effluent into 4 fractions, numerical examples of oil yields, the potential downstream separations into sub-fractions and their potential application as refinery syncrude oil, electrode binder pitch, feed for wax products and coal-tar chemicals. As can be appreciated by those skilled in the art, this example illustrates a preferred application of the process without limiting its applicability in any way as to the number of fractions, yields, temperatures or downstream processing or disposition of the products. In this example the multi-step recovery process results in the separation of four liquid fractions and a gas-phase. This separation is useful because these fractions are designated for different downstream processing. The oil yields are typical ranges for Western low-rank-coals. TABLE showing coal-tar-oil fractions, yields and prospective sub-fractions:

| | | | Oil-Yield Examples | | | | |
|---|---|---|---|---|---|---|---|
| | | Temperature | Range, | | | Feedstock | Downstream |
| Fraction # | | Degrees, F. | wt % | wt % | wt % | Fraction | Processing |
| 1 | A | 850+ | 16-24 | 18 | | syncrude | hydrocracking |
| | A-1 | | | | 18 | syncrude | delayed coking |
| | A-2 | | | — | 15 | binderpitch | visbreaking |
| 2 | B | 650-850 | 28-38 | 31 | | syncrude | hydrocracking |
| | B-1 | | | — | 15 | waxes | extraction |
| | B-2 | | | — | 15 | binderpitch | visbreaking |
| 3 | C | 450-650 | 25-40 | 28 | | syncrude | hydrotreating |
| | C-1 | | | — | 14 | waxes | extraction |
| 4 | D | 250-450 | 15-25 | 23 | | | |
| | D-1 | | | | 10 | syncrude | refining, HT |
| | D-1 | | | — | 10 | cresylics | extraction |
| | D-2 | | | — | 3 | pyridines | extraction |
| Total | A-D | 250-900+ | 100 | 100 | | | |

| | | | | | |
|---|---|---|---|---|---|
| 4 | E | 135-250 | 1-2 | 0.5 | naphtha range hydrocarbons |
| | Water | 135-212 | — | — | — |

| | | |
|---|---|---|
| 5 | F | Non-condensable gasses - - - reports to fuel gas |

### Example-05, Fractions 650+° F. and 850+° F.

A sample of coal-tar-oil was fractionated by distillation and the 650+° F. fraction was separated by short-path wiped-film vacuum distillation into a lower boiling wax fraction [650-900° F.] and a residual pitch fraction [850+° F.] that may have considerable higher value than as refinery feedstock for motor fuel. The wax and pitch fractions also can be separated by solvent extraction as is practiced for extraction of Montan wax from coal. The wax fraction was separated into various fractions with characteristics that match market specifications. After separation, the pitch fraction can be thermally treated at 1400-1500° F. to convert it into higher value “electrode-binder pitch”. Material not converted into specialty product can report to the syncrude pool for use as feedstock for oil refinery processing with visbreaking, delayed coking, hydrocracking or hydrotreating.

### Example-06, Fraction 450-650° F.

A sample of coal-tar-oil was fractionated by distillation and the composition determined by GC. This fraction contains valuable chemical compounds that are highly polar in nature in addition to non-polar hydrocarbons. Depending on the feed-coal and MTP operation, the weight ratio of polar compounds to non-polar hydrocarbons is 0.10-0.25. The following table shows a typical example for illustration. The composition of the 450-650° F. coal-tar-oil fraction was identified as follows. Sub-fractions from 450-650° F. Fraction [ref.: BDM 9/20/97]

| | Acids | Bases | Neutrals | Total |
|---|---|---|---|---|
| | Wt % | wt % | wt % | wt % |
| Sub-fraction | | | | |
| Extraction | 47.7 | 6.6 | 45.7 | 100.0 |
| Sub-fraction, of total Analysis | 15.2 | 2.1 | 14.6 | 31.9 |
| C | 74.3 | 76.9 | 85.7 | |
| H | 7.5 | 8.2 | 11.2 | |
| O | 17.9 | 9.6 | 2.2 | |
| N | 0.03 | 4.6 | 0.5 | |
| S | 0.3 | 0.7 | 0.4 | |
| Total | 100.0 | 100.0 | 100.0 | |
| Ratio H/C | | | 1.57 | |
| SpGr., g/ml | | | 0.814 | |
| Composition: [phenol-free basis] | | | | |
| Aromatics | | — | — | 51.0 |
| n-paraffins | | — | — | 3.8 |
| iso-parasffins | | — | — | 13.9 |
| naphthenes | | — | — | 7.4 |
| olefins | | — | — | 19.9 |
| others | | — | — | 4.0 |
| Total | | — | — | 100.0 |

### Example-07, Fraction 450-650° F.

A sample of recovered coal-tar-oil was fractionated by distillation and the composition determined by GC. The composition of the 450-650° F. coal-tar-oil fraction was identified as follows.

Composition basis:

| | Total | 450-650° |
|---|---|---|
| | Coal-tar | F. fraction |
| Compound Group: | wt % | wt % |
| Alkyl-phenolics, cresylic acids | 7.1 | 23 |
| Alkyl-indanols, naphthols and byphenylols | 3.5 | 12 |
| Alkyl-pyridines, quinolines, amine-bases | 2.6 | 9 |
| Alkyl-naphthalenes | 0.5 | 2 |
| Non-polar hydrocarbons | 14.8 | 49 |
| Other compounds | 1.5 | 5 |
| Total | 30.0 | 100 |

### Example-08, Fraction-D, 206-480° F.

A sample of coal-tar-oil was fractionated by distillation to identify the low boiling fraction from the initial boiling point [IBP] to 482° F. [bottom temperature]. The yield of this fraction was 1.0-w % of the total recovered coal-tar-oil. The distillation range of this fraction at normal pressure was as follows. Composition of the recovered distillate was 50/50 oil/water. As expected the oil is mostly low boiling C-5-C-7 hydrocarbons that co-distil together with water at 97-110° C.

| Distilled Volume Wt-% | Condensation Bottoms | | | |
|---|---|---|---|---|
| of total oil | Temperature | | Temperature | |
| IBP | 101° C. | 214° F. | 154° C. | 309° F. |
| 0.25 | 98 | 208 | 174 | 345 |
| 0.50 | 97 | 206 | 193 | 379 |
| 0.75 | 98 | 208 | 220 | 428 |
| 1.00 | 110 | 230 | 250 | 482 |

### Example-09, Coal-Tar-Oil Compound Group Identification

Several samples from coal-tar-oil recovered from MTP were inspected to determine variations in composition over time [approximately the same process conditions as per the previous coal-tar-oil example]. More than 165 individual compounds were identified out of more than 1000+ present.

| | | | | | Number of |
|---|---|---|---|---|---|
| Sample # | | 1 | 2 | 3 | Identified |
| | Compound Group | w % | w % | w % | Compounds |
| Methyldichloride | Cresylic acids, phenols | 6.2 | 5.94 | 6.9 | 18 |
| soluble | Catechols | 4.7 | 4.69 | 3.5 | 24 |
| fraction: | Neutral HC oils | 74.11 | incl | 74.1 | 86 |
| | N-bases | 2.65 | incl | 3.5 | 24 |
| | Ether-extract of | 5.24 | incl | 5.3 | 13 |
| | 900 + F. fract. | | | | |

| | | | | |
|---|---|---|---|---|
| Methyldichloride insoluble | 7.09 | incl | 6.7 | 15+ |
| Other | nil | 86.11 | nil | + |
| Total | 100 | 100 | 100 | 165+ |

### Example-10, PHENOLIC FRACTION COMPOUND YIELD IDENTIFICATION

The cresylic acid fraction containing phenols, cresols and catechol compounds was separated from the 450-650° F. fraction and the compounds were identified with GC/MS assay.

| | | w % of | w % |
|---|---|---|---|
| | Compound: | fraction | of total |
| I. Cresylic acid fraction: | Phenol | 15.0 | 0.88 |
| 5.9-w % of total | 0-cresol | 9.0 | 0.53 |
| coal-tar oil | m/p-cresol | 30.5 | 1.83 |
| | 2,4/2.5-xylenol | 7.0 | 0.41 |
| | p-ethyl-phenol | 8.0 | 0.47 |
| | Me—Et-phenol | 8.6 | 0.51 |
| | Identified others | 11.5 | 0.68 |
| | Unidentified others | 10.0 | 0.59 |
| | Total | 100.0 | 5.90 |
| II. Catechol fraction: | Catechol | 38.4 | 1.79 |
| 4.67-w % of total | 3-m-catechol | 10.5 | 0.49 |
| coal-tar oil | 4-m-catechol | 30.8 | 1.44 |
| | Others | 20.3 | 0.95 |
| | Total | 100.0 | 4.67 |

### Example-11, Comparison of Coal-Tar Pitch Fractions

Samples of pitch fractions from coal-tar-oil recovered from MTP and HTP were prepared by distillation under vacuum. The characteristics were analyzed and the results are compared below.

| | High-temperature | | Mild-pyrolysis | | | |
|---|---|---|---|---|---|---|
| Coal-tar type process | Coke-oven-pitch | | 950-1100° F. | | | |
| Characteristic: | typical spec | | Fraction | | Fraction | |
| Fraction | 700+° | F. | 650-900° | F. | 900+° | F. [a] |
| Softening point* | 88-121° | C. | 48° | C. | 65-91° | C. |

| Sp. Gr., at 25° C., g/ml | >1.32 | 1.117 | 1.122 | |
|---|---|---|---|---|
| Flash point, COC | — | — | 254° | C. |

| | | | |
|---|---|---|---|
| Atomic ratio, H/C | >1.75 | — | 1.175 |
| Coking value* | 55-60% | 25% | 36% |
| Ash | 0.25% | nil | nil |
| Sulfur | <0.6 | 0.3 | 0.3 |
| Distillation to 680° F. | 2.5 | <3.8 | <1.0 |
| Toluene insoluble, w %* | 26-32 | 7.7 | — |
| Quinoline insoluble, w % | 8-15 | — | — |
| Total soluble in CS2 - | | — | 70% |

[a] Pitch fraction Distillation bottoms, 250° C., 20-mm Hg abs.
*Certain minimum requirements for use as “eletrode binder pitch”

### Example-12, Hydrotreating of Coal-Tar-Oil

Conversion of coal-tar fraction 450-650° F. to syncrude oil was conducted by fixed bed catalytic hydrotreating at 675° F., 900-psia, 1600 2100 SCF/bbl at 2-4 LHSV, with Topsoe Ni/Mo catalyst TK-555 [Ref. BDM Phase-1 Final Report, 9/10/97] producing 21-25 API syncrude oil. Conversion was 85-90-%, and the product is a suitable feedstock for naphtha [gasoline fraction] and light-atmospheric gas-oil [diesel fuel fraction] processing. Removal of the polar compounds [catechol, cresylic acid and N-bases fractions] from the coal-tar feedstock results in significant savings in hydrogen consumption in the order of 15-30-%. Removal of the 900+° F. high boiling coal-tar-pitch fraction, which may have better use as electrode binder pitch or delayed-coke feedstock, also decreases the hydrotreating cost and increases the yields of desirable hydrocarbons. The coking process yields a light-cycle-oil that can be used as feedstock in the hydrotreater. An alternative to hydroterating at the above mentioned operating conditions, is applying a high-pressure process such as the HTI hydrotreating designed for coal conversion and using a homogeneous slurry catalyst and 3000-psia pressure of higher. In this case the presence in the recovered coal-tar-oil of 900+° F.-HT-pitch and coal-fines that tend to form deposits on fixed-bed catalysts, do not present unusual problems. Several similar alternative hydrotreating process are in operation on feedstock derived from tar-sand oil extraction, oilshale and coal-to-liquid, and the choice of process is an economic decision based on the cost, experience, feedstock quality, product slate and commercial warranties provided for each site specific project. The data from hydrotreating to produce synthetic crude oil exemplefies the acheivable product quality (see attachment 1 and 2).

### Example-13, Coking of Heavy Fractions After Distillation

A sample of coal-tar-oil was fractionated by vacuum distillation into a 650-900° F. fraction and a 900+° F. fraction, and each fraction was subjected to delayed coke processing at two different conditions, as shown below. The recovery yield of distillates is 52-61 w %, coke 32-42-w % and fuel gas 3.5-4.3-w %.

| Coal-tar fraction: | |
|---|---|
| [650-900° F.] | [900+° F.] |
| Yield range on total coal-tar | |
| [16-24-w %] | [28-38-w %] |

| Coking Test # | A | B | C | D |
|---|---|---|---|---|
| Temperature, avg., C. | 505 | 535 | 515 | 540 |
| Deg. F. | 941 | 993 | 959 | 1004 |
| Mass balance: | w % | w % | w % | w % |
| Gas | 3.5 | 4.2 | 3.7 | 4.3 |
| Distillates: | | | | |
| Gasoline fraction | 6.6 | 7.8 | 7.2 | 7.3 |
| Diesel fraction | 13.1 | 13.3 | 13.3 | 13.8 |
| Heavy Gas oil fraction | 43.8 | 40.6 | 31.6 | 31.3 |
| Sub-total distillates | 63.5 | 61.7 | 52.1 | 52.4 |
| Coke | 31.9 | 31.8 | 42.3 | 41.4 |
| Total recovery | 98.9 | 97.8 | 98.1 | 98.1 |

| Distillates | wt % of coal-tar | |
|---|---|---|
| Yield | [10-15] | [15-20] |

### Example-14, Electrode Binder Pitch

Electrode-binder pitch for electrode manufacturing is made from high-temperature coke-oven tars. However, the 650+° F. fraction of MTP coal-tar-oil can serve the same purpose after undergoing thermal cracking at 1300-1500° F. Depending on the LRC feedstock quality, the MTP process temperature and residence time, and the selected coal-tar fraction, a suitable electrode-binder pitch can be produced. Samples of 650+° F. and 900+° F. fractions distilled from MTP coal-tar-oil were processed and tested in mixtures for this purpose.

### Example-15, Coal-Fines Removal Form Coal-Tar-Oil

The 450-650° F. fraction was filtered to remove active carbon coal-fines material immediately after condensation. This is important to prevent polymerization and instability of the chemically reactive polar compounds. Increasingly finer filters were tested to determine throughput versus carbon retention down to micron particle size. It was found that essentially all coal-fine material can be removed with a single 5-micron filter, but that several filters of decreasing fineness accelerates the filtration process and decrease the pressure drop of the overall process. Specific filtration rates were not determined because the scale-up to larger capacity will be defined by pilot operation in commercial vendor testing equipment.

1-29. (canceled)

30. A process for recovering oil from pyrolysis vapor phase produced during mild temperature pyrolysis of a low rank coal by simultaneous fractionation of coal-tar-oil liquids, the method comprising:
extracting the coal-tar-oil in vapor phase as one of the end-product of mild temperature pyrolysis process of a low rank coal using a sweeping gas;
optimizing the recovered coal-tar-oil from the vapor phase and reduced the amounts of non-condensing gas compounds by sequentially passing the high temperature vapor phase through a plurality of vapor condensing unit such that each vapor condensing unit operates at a defined temperature which is lower than the temperature in preceding vapor condensing unit to condense a fraction of coal-tar-oil liquid;
wherein each sequential vapor condensing unit separates a different fraction of the coal-tar-oil liquid which has a condensing point within the operating temperature range of corresponding vapor condensing unit.

31. The process of claim 30, wherein the vapor phase is recovered and condensed into several fractions by means of contacting the uncondensed vapors sequentially with product condensate-recycle streams cooled stepwise to a lower temperature in order to obtain in each step a predetermined condensation temperature and liquid product quality, and where the condensation temperatures are in the ranges of 750-850° F., 625-700° F., 425-675° F., 235-265° F. and 110-145° F.; and preferentially 825-850° F., 645-665° F., 440-460° F., 245-255° F. and 110-130° F., or more preferentially 845° F., 650° F., 450° F., 250° F. and 120° F.

32. The process of claim 30, wherein the mild temperature pyrolysis is conducted at a temperature below 1150° F. in the presence of the sweeping gas.

33. The process of claim 30, wherein the coal-tar-oil vapor phase contains the volatile material which is then recovered and simultaneously fractionated into the plurality of oil fractions.

34. The process of claim 30, wherein in each of the vapor condensing unit, the vapor phase is contacted with a condensed liquid material in a quench column followed by a surface-contact packing for condensation and droplet agglomeration.

35. The process of claim 34, wherein the condensed liquid material is circulated through a heat exchanger where it is cooled to attain the temperature of the corresponding vapor condensing unit and is recycled back into the quench column.

36. The process of claim 34, wherein the condensed fraction of coal-tar oil is removed from the vapor condensing unit for downstream processing.

37. The process of claim 30, wherein one of the plurality of vapor condensing unit operates at temperature above 650° F.

38. The process of claim 30, wherein one of the plurality of vapor condensing unit operates at temperature within range of 450° F. to 650° F.

39. The process of claim 30, wherein one of the plurality of vapor condensing unit operates at temperature within range of 250° F. to 450° F.

40. The process of claim 30, wherein one of the plurality of vapor condensing unit operates at temperature within range of 130° F. to 250° F.

41. The process of claim 38, wherein the fraction of coal-tar-oil condensed form the vapor condensing unit operating at temperature within 450° F. to 650° F., is further treated to remove coal fines by using cyclone separators, filtration or a combination thereof.

42. The process of claim 30, wherein the different fraction of coal-tar-oil derived from each of the plurality of vapor condensing unit are further fractionated into separate sub-fractions of polar compounds and non-polar compounds and wherein the non-polar compounds are refined into a synthetic crude oil refinery feedstock fraction, one or more wax fractions, and an electrode-binder-pitch feedstock fraction.

43. A system for recovering oil fractions from pyrolysis vapor effluent produced during mild temperature pyrolysis of a low rank coal, the system comprising:
a pyrolysis system for producing a coal-tar-oil vapor effluent phase as one of the end-product of mild temperature pyrolysis process of a low rank coal using a sweeping gas;
a plurality of vapor condensing unit arranged sequentially for optimizing the recovered coal-tar-oil from the vapor phase and reducing the amounts of non-condensing gas compounds in the vapor effluent, each of the said plurality of vapor condensing unit operates at a temperature lower than the preceding vapor condensing unit;
wherein the vapor condensing unit comprises a condensed liquid material that when contacts with the vapor effluents condensed the uncondensed vapor present in the vapor effluent which has a condensation point equivalent to the corresponding vapor condensing unit.

44. The system of claim 43, wherein the mild temperature pyrolysis is conducted at a temperature below 1150° F. in the presence of the sweeping gas.

45. The system of claim 43, wherein in each of the vapor condensing unit, the vapor phase is contacted with a condensed liquid material in a quench column followed by a surface-contact packing for condensation and droplet agglomeration.

46. The system of claim 43, wherein the condensed liquid material is circulated through a heat exchanger where it is cooled to attain the temperature of the corresponding vapor condensing unit and is recycled back into the quench column.

47. The system of claim 43, wherein the condensed fraction of coal-tar oil is removed from the vapor condensing unit for downstream processing.

48. The system of claim 43, where the condensation temperatures are in the ranges of 750-850° F. 625-700° F., 425-675° F., 235-265° F. and 110-145° F.; and preferentially 825-850° F., 645-665° F., 440-460° F., 245-255° F. and 110-130° F., or more preferentially 845° F., 650° F., 450° F., 250° F. and 120° F.

49. The system of claim 43, wherein the different fraction of coal-tar-oil derived from each of the plurality of vapor condensing unit are further fractionated into separate sub-fractions of polar compounds and non-polar compounds and wherein the non-polar compounds are refined into a synthetic crude oil refinery feedstock fraction, one or more wax fractions, and an electrode-binder-pitch feedstock fraction.
